(19) United States
(12) Patent Application Publication
(10) Pub. No.: US 2010/0131465 A1
(43) Pub. Date: May 27, 2010

(54) METHOD FOR DUPLICATING A DATABASE IN A NETWORK OF MACHINES, AND SYSTEM OF MACHINES COMPRISING A DUPLICATED DATABASE

(75) Inventor: Laurent Deniel, Le Plessis Robinson (FR)

Correspondence Address: LOWE HAUPTMAN HAM & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 11/721,149

(22) PCT Filed: Dec. 2, 2005
(86) PCT No.: PCT/EP05/56446

§ 371 Date: Jun. 7, 2007

(30) Foreign Application Priority Data
Dec. 7, 2004 (FR) 04/13020

(51) Int. Cl. G06F 17/30; G06F 17/00; G06F 12/16

(52) U.S. Cl. 707/613; 707/638; 707/E17.032; 707/E17.005; 711/E12.103

(57) ABSTRACT

The invention relates to a method for duplicating a database in a network of machine, and to a system of machines comprising a duplicated database. Said machines (1, 2, 3) share the same database (10) which is duplicated in the machines. A first machine (1) transmits data (A) updated in the database thereof to the other machines (2, 3). A master machine (31) converges the databases (10) between the machines. To this end, the machine (1) transmitting the data (A) emits, in the same message as the data (A), the version number thereof and the address of the machine; the machine (1) also emits the message to a master machine (31); a machine (31, 2, 3) publishes the data (A) in the database (10) thereof, following a version number test; and the master machine (31) emits a central announcement message (32, MAC) to the machines (1, 2, 3), said central announcement message comprising the version number thereof for all of the data in the database (10), and the address of the machine (1) at the origin of the updating thereof. The invention especially applies to the duplication of databases in a large number of machines connected in a network, for example in air traffic management systems.

### CROSS REFERENCE TO RELATED APPLICATIONS

The present application is based on International Application No. PCT/EP2005/056446, filed on Feb. 12, 2005, which in turn corresponds to French Application No. 04 13020 filed on Jul. 12, 2004 and priority is hereby claimed under 35 USC §119 based on these applications. Each of these applications are hereby incorporated by reference in their entirety into the present application.

### FIELD OF THE INVENTION

The present invention relates to a method of duplicating a database in a network of machines. It also relates to a system of machines with duplicated database. It applies in particular to the duplication of databases among a large number of networked machines, for example in the context of air traffic management systems.

### BACKGROUND OF THE INVENTION

Networked systems of machines operate with increasingly large numbers of machines connected. Such is the case, for example, with air traffic management systems which can include several hundred machines, operating either as server stations or as client stations. In such a system, the machines typically access a common database. In an air traffic management application case, such a database typically comprises flight plan data, meteorological data, runway data, and so on. All this data needs to be accessible to all the machines in the network. To this end, the database is duplicated in each of these machines. Nevertheless, over time, the data evolves. The database must therefore be duplicated regularly. Normally, the updating of a data item is performed by one machine in the network, particularly by a server. Once the machine has completed the update, it transmits this update to the other machines in the network.

Several solutions are known for duplicating data in a local area network. A first solution involves transmitting the data in point-to-point mode from the station originating a data modification, for example a server, to the other stations in the network, for example client stations. A point-to-point transmission means that the sending station transmits the updated data in turn to each client station. In a system with a large number of stations, for example several hundred, the overall updating of the databases can take a very long time which is incompatible with the current application.

Another solution uses multicast transmission. The multicast transmission makes it possible to send just once from the sending station, the updated data being simultaneously transmitted to all the other stations in the network, so again it is essential to ensure that the transmitted data is correctly received. Thus, in a system where the reliability of the data is critical, such as an air traffic management system in particular, it is essential to check that the data is correctly transmitted. To this end, it is necessary to use acknowledgements. In this case, the sending station must wait for the acknowledgements from all the machines in the network. Here, too, if the network has a large number of machines, the wait for all the acknowledgements can take too long, which is incompatible with the application. To reduce this time, it could be possible to use negative acknowledgements instead of the acknowledgements as indicated previously. The use of negative acknowledgements means that a client station for example retransmits an acknowledgement only if it does not receive data. However, the problems of detecting the non-reception of the data and management of the tolerance to software or hardware failures of the sender in particular still remain. In addition to these problems, there is still a time waiting for the negative acknowledgements which needs to be managed, this waiting time possibly also being too long.

All these solutions therefore have the particular drawbacks of being too slow and/or not reliable enough.

### SUMMARY OF THE INVENTION

One object of the invention is, in particular, to overcome the above-mentioned drawbacks. To this end, the subject of the invention is a method of duplicating a database among the machines of a network, a machine of the network transmitting a data item A updated in its database to the other machines. According to this method:
the machine originating the data item A transmits, in one and the same message with this data item A, its version number and the address of the machine;
the machine also transmits the message to a master machine;
a machine publishes the data item A in its database after a version number test;
a master machine periodically transmits a central announcement message to the machines, this central announcement message comprising, for each data item in the database, only its version number and the address of the machine originating its update.

When a central announcement message (MAC) is received, a machine compares the versions of the data items in its database with the versions of the central announcement message (MAC), the machine requesting the transmission of a data item A to the master machine when the version number of the data item A is less than the version number of the central announcement message (MAC).

The machine originating the data item A retransmits for example this data item to the other machines and the master machine when the version number of the data item A that it has transmitted is greater than the version number of the central announcement message (MAC).

Advantageously, when a machine transmits two linked data items A, C, on reception, the machines store the received data items in a buffer area, the linked data items A, C being published in the local database only when they have the version transmitted by the originating machine.

Advantageously, the central announcement message (MAC) is transmitted periodically, independently of the transmissions of data items A by a machine (1).

The network of machines can be an air traffic management system.

Another subject of the invention is a system of networked machines sharing one and the same database, the database being duplicated in the machines, an originating machine transmitting a data item A updated in its database to the other machines, the system comprising a master machine which converges the databases (10). To this end:
the machine (1) originating the data item (A) transmitting, in one and the same message with this data item (A), its version number (41) and the address (42) of the machine;
the machine (1) also transmitting the message to a master machine (31);
the master machine (31) transmitting a central announcement message (32, MAC) to the machines (1, 2, 3), this central announcement message comprising, for each database (10), its version number and the address of the machine (1) originating its update;
a machine (31, 2, 3) publishing the data item (A) in its database (10) after a version number test.

The main advantages of the invention are that it applies to numerous systems sharing one and the same database, that it applies to systems with very large numbers of machines without affecting performance, that it is simple to implement and that it provides a total tolerance to multiple software or hardware failures.

### BRIEF DESCRIPTION OF THE DRAWING

Other characteristics and advantages of the invention will become apparent from the description that follows given in light of the appended drawings which represent:

FIG. 1, an exemplary network of machines sharing one and the same database, typically comprising one server and N client stations;

FIG. 2, an exemplary structure of a database;

FIG. 3, an illustration of how to implement the method according to the invention applied to the exemplary network of FIG. 1;

FIG. 4, an exemplary structure of a central announcement message designed to converge the databases;

FIG. 5, an exemplary central announcement message on initialization of the databases;

FIG. 6, the system of FIG. 3 after transmission of a first record A;

FIG. 7, a state of the data table and of the associated central announcement message at a given instant;

FIG. 8, an exemplary structure of a message comprising records sent by a machine originating updates;

FIG. 9, an illustration of the function of a buffer area used before a database is updated.

### DETAILED DESCRIPTION OF THE DRAWING

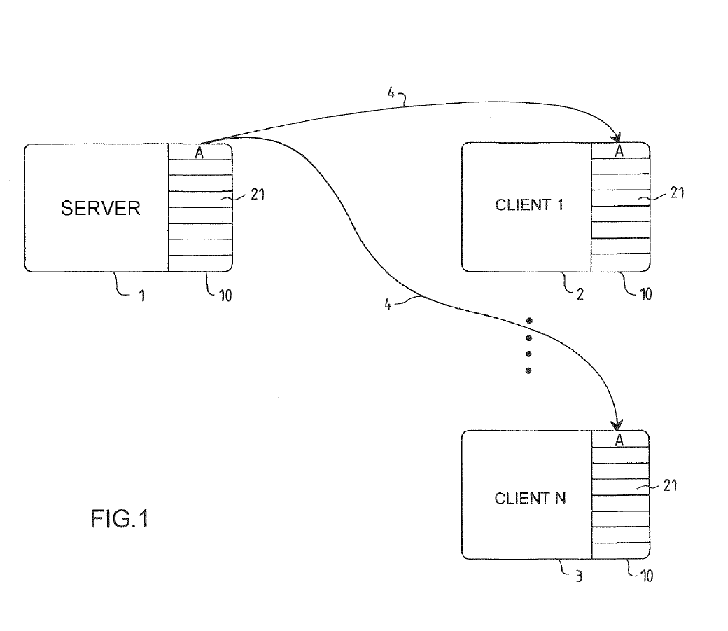

FIG. 1 shows a network of machines. For simplicity, only three machines are shown, a server station 1 and two client stations 2, 3 in a network of N clients. The network could obviously have other servers. Again for simplicity, only the server initiates the updating of the data. The data could also be updated by other servers. It could also be updated by client stations. The machines 1, 2, 3 share one and the same database 10. This database updated by the server 1 is distributed to the clients 2, 3.

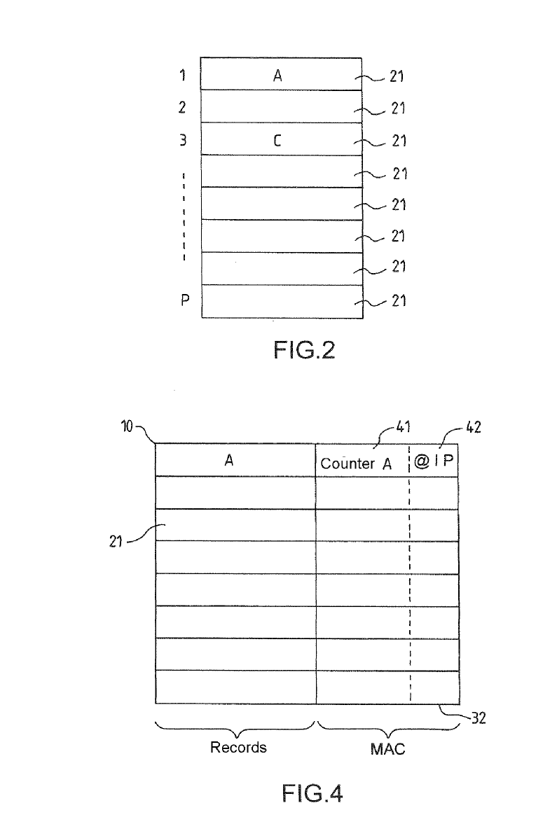

FIG. 2 shows an exemplary structure of such a database. The database 10 comprises a series of data items 21. In an air traffic management application, for example, each data item corresponds to a record. It can be, for example, a flight plan record, a meteorological data item, a runway data item or any other information relating to air traffic management. The database 10 therefore has a whole series of records 21 regularly updated by the server 1, these records being duplicated in each of the machines in the network. Hereinafter, as an example, it will be considered that a data item 21 in the database 10 is a record. The latter could, however, be data types other than records. FIG. 2 therefore shows a database comprising P records 21. To describe operation of the method according to the invention, the updates of two data items, a record A and a record C, will be examined.

Returning to FIG. 1, the server writes a new record A then uses a multicast transmission 4 to transmit this record A to the client stations 2, 3. The multicast link enables the server to execute a single transmittal, the record A being simultaneously distributed to all the clients. In such a configuration, the clients 2, 3 retransmit to the server a positive acknowledgement or a negative acknowledgement. A positive acknowledgement is sent to indicate that the record is correctly received and a negative acknowledgement is sent to indicate that a record is not received. Drawbacks of both these distribution methods have in particular been mentioned previously.

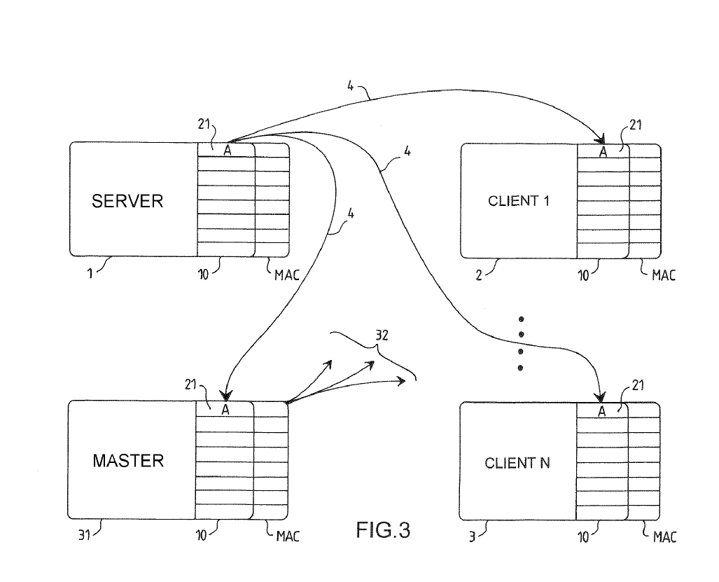

FIG. 3 illustrates one implementation of the method according to the invention. The network system has the same machines 1, 2, 3 as the system of FIG. 1. It also comprises a master machine 31. This machine can, for example, be a server or a client station. Preferably, this machine is dedicated to its master function as described below. Like the other machines 1, 2, 3 in the network, the master hosts the database 10.

As an example, the updating of the record A is repeated. The server therefore writes a new record A into its own database 10. Then, as in the case of FIG. 1, it transmits this record A via multicast link 4 to the client stations 1, 2 and also to the master 31. On receiving the record A, the clients 2, 3 and the master 31 write the record A in the corresponding location 21 of the database 10. The clients 2, 3 and the master 31 do not send acknowledgements to the machine originating the record A, in this case the server 1 in the example of FIG. 3.

The method according to the invention periodically converges the data tables together, independently of the updates. The convergence period depends in particular on the application. The master 31 helps handle the convergence of the data tables 10. For the system to operate correctly, it is essential in particular that, at given instants, all the duplicated databases 10 have the same data. It is, for example, essential for all the machines to have one and the same record of a flight plan at a given instant or one and the same record of meteorological information to ensure the reliability of the whole system. The master station 31 periodically sends a central announcement message 32 (MAC) to all the other machines 1, 2, 3 in the network, including to the machine 1 originating the updates. This MAC message is, in particular, intended to converge the databases 10 of the machines 1, 2, 3 in the network.

FIG. 4 shows the structure of a central announcement message 32 with respect to the database 10. This message in practice comprises a series of data items coupled to the records in the database 10. FIG. 2 shows that a location of the database 10 comprises a record, A for example. In this same location, or opposite or corresponding to this same location, the database also has a counter 41 and an IP address 42. The counter indicates the version number of the record, more particularly, the counter indicates the result of the count of the number of modifications made to the record A since a given initial record.

This structure of a record A, complemented by its counter and the IP address of its originating machine is repeated for all the records in the database.

Thus, according to the invention, a machine 1 which writes a new record A in a database increments the counter of this record and writes its own IP address in reserved locations in the database. Then, the machine 1 transmits the record A, accompanied by its counter and its IP address, to the other machines 2, 3 and in particular to the master station 31.

The set of counters of all the records and the IP addresses of the machines originating records, in fact the complementary data placed, for example, in the locations 41, 42 as described previously, this set forms the central announcement message 32 periodically sent by the master station 31 to all the other machines. This message 32 is, for example, sent via the multicast link. The data in this message will hereinafter be called MAC data.

On receiving this MAC message sent by the master 31, the slaves perform a test with their own MAC data which is updated at the same time as new records are received, these slaves naturally being all the other machines 1, 2, 3 of the system that share the same database.

To return to the case of the record A, when the server 1 writes then transmits the new record A it also transmits the updated counter and its IP address. The clients 2, 3 and the master then store this new record A in their database 10 together with the updated counter and the IP address in the corresponding locations 41, 42. Each client 2, 3 therefore comprises the MAC data of a central announcement message 32. This data is updated as and when new records are received, line by line. Then, periodically, it receives from the master station the central announcement message 32 comprising all the MAC data. The client then compares its MAC data with the MAC data in the central announcement message 32 sent by the master 31.

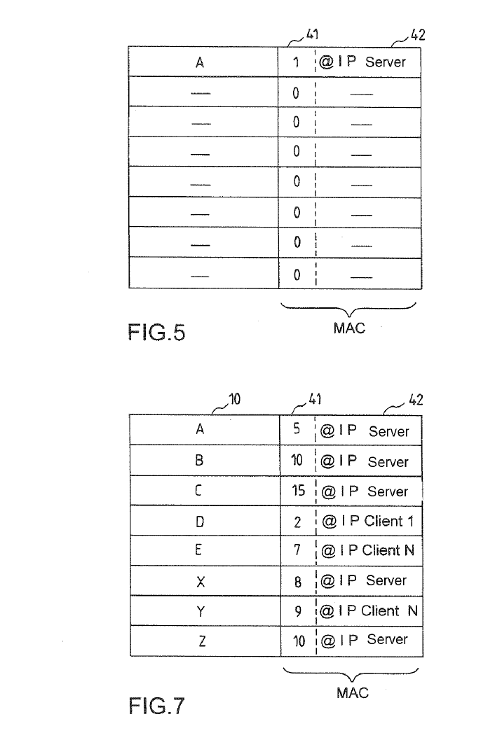

FIG. 5 shows an MAC message on creation of a first record A. This first record is, for example, written by the server 1 in its database 10. The server also writes the version number, that is, increments the counter of the record A to 1 and enters its IP address in the corresponding field 42. Then, the server transmits, via the multicast link 4, the record A, the counter value, therefore the version number of the record A, and its IP address to the other machines in the network, that is to the client stations 2, 3 and to the master 31.

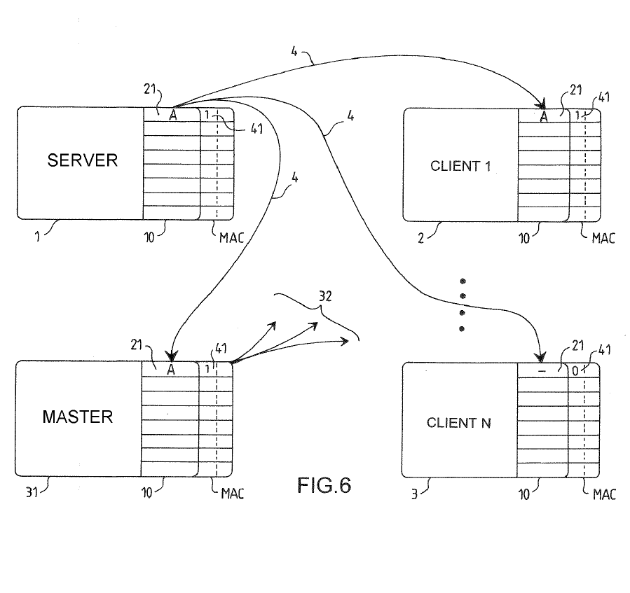

FIG. 6 shows the system of FIG. 3 after this first record A has been transmitted. In the example shown, a client 3 has not received the message. In this case, the counter remains at 0 in the location 41 reserved for the word A in the database 10, in this client 3. Since the other client 2 and the master have correctly received the data transmitted by the server 1, they have the right version number for the record A, in this case the version 1 here on initialization. The location 41 reserved for the counter for the record A is correctly set to 1 for this client 2 and for the master 31.

Then, the master sends the central announcement message 32, the MAC message. The MAC message has a structure known to all the machines, so as to enable each of them to identify the counter associated with each of the records and the IP addresses of the sending machines. To this end, the MAC message for example has a serial structure which presents in turn the counter and the IP address associated with each of the records. The MAC message is, for example, transmitted via the multicast link. On receiving the MAC message, the receiving machines 1, 2 and 3 compare this MAC message transmitted by the master 31 with their own MAC message. In particular, they compare each of the version numbers of the words of the database 10 with the corresponding version numbers transmitted by the master. In the example of FIG. 6, the machines compare the value of the counter of the location 41 reserved for the word A with the value of the counter entered in the MAC message transmitted by the master. For the result of the comparison to be conclusive, the counter values must be identical, in this case equal to 1 in the example of FIG. 6. In this example, a client 3 has not received the record A and therefore its counter has remained at 0 in the reserved location 41. More generally, a record A has not been received by a machine if:

Cpt A_{machine}<Cpt Aₘₐₛₜₑᵣ (1)

where Cpt A_{machine} is the counter of the record A in the machine and Cpt Aₘₐₛₜₑᵣ is the counter of the record A in the MAC message sent by the master. The relation (1) does not, however, apply when the master 31 has crashed.

When the client station 3 notices that the record A has not been transmitted following the test (1), it typically asks for this record A to be sent to the master station 31. More generally, when a client station requests the transmission of the records that do not have the same version number as the MAC message, that is whose associated counters satisfy the relation (1), the master 31 then retransmits the records requested by the client, for example in multicast mode. In multicast transmission mode, the record or records sent by the master 31 are sent to all the other machines 1, 2, 3, including those that have correctly received the record. These other machines carry out the test according to the relation (1) and do not react because this test then indicates that the records they contain have the right version.

The invention also advantageously makes it possible to deal with the case of a machine being inserted into the network. Such a machine then asks the master for all the records in the database following the tests (1). Following the tests, the machine then acts as another machine having wrong version numbers. In this case of a machine being inserted, the request for retransmission of all the records by the master can cause the network to be saturated. To avoid this saturation, the machine typically initially asks for only some of the records. More generally, to avoid one-off overloads on the network, the master for example sends a subset of the records in a given period, or even sends one and the same record just once in a given period.

In another case of transmission failure, it may be the master 31 that does not receive the record A. Its counter then remains at zero, particularly in the example of FIG. 6. In this case, the client 3 which is in the same state as the master, that is, which has not received the record A, does not react and does not therefore ask for the master to transmit the record A. In practice, in this case, the test according to the relation (1) is inoperative. The client 3 does not satisfy the relation (1) and yet it has not received the record A. This client station 3 therefore does not notice that it has not received this record A.

The other clients 2 that have correctly received the record A do not satisfy the relation (1) because they in fact have a version number higher than that of the master. For a machine that has received the record A, the counter then satisfies the following relation:

Cpt A_{machine}>Cpt Aₘₐₛₜₑᵣ (2)

A machine that satisfies the relation (2) therefore knows that it has received the record A. It can therefore transmit the record A to all the machines, including the master, together with all the other records for which it satisfies the relation (2). However, to avoid saturation on the network, it is preferable for a single machine to transmit the record A. This can then be the machine that is originating the modification of the record A, that is the writer. In the example of FIG. 6, it is, therefore, for example, for the server 1 to transmit the record A that it is originating. The machine that is originating a record is clearly identified in the MAC message in particular through its IP address placed in the location 42 opposite the counter. In the event of simultaneous failure of the writer and nonreception from the master 31, a client machine (out of 1, 2, 3) has the responsibility for retransmitting the record A. This situation is detected by the machines that have received the record A if the MAC message sent by the master satisfies the relation (2) for N consecutive periods.

In the event of total failure of the master machine 31, a new master is automatically elected. This failure is detected by the non-reception of the MAC message for N consecutive periods.

There then in particular remains a case to be taken into account which is the one where it is the server 1 that has failed and, more generally, where it is the machine that is originating the record that has failed. By referring to FIG. 6, in this case, neither the master 31 nor the other machines 2, 3 receive the record A. To overcome this type of failure, it is possible to provide a redundant system but it is hardly critical because all the databases of the system are still consistent (none contains the record A).

FIG. 7 shows a state of the table 10 and of the associated MAC message at a given instant. This table 10 is duplicated in all the machines. In each machine, the table 10 occupies a reserved memory space, and a memory cell 21 is reserved for each record. The same applies for the MAC message which has a memory space. A series of memory cells 41 thus indicates the version numbers of the records, via counters. Another series of memory cells 42 indicate the IP addresses of the machines originating the records. The records can be independent of each other, but they can also be linked. Such is in particular the case when transactions are involved. In practice, there is a relationship between two tables and the updating of the records must be done simultaneously. It is assumed, by way of example, that the data items A and C are linked.

It is therefore essential for the clients 2, 3 to receive A and C at the same time. More specifically, it is essential that, in the event of A not being received by a client, C is not visible by this client. It is important to ensure that the client cannot use a right version of C with the wrong version of A.

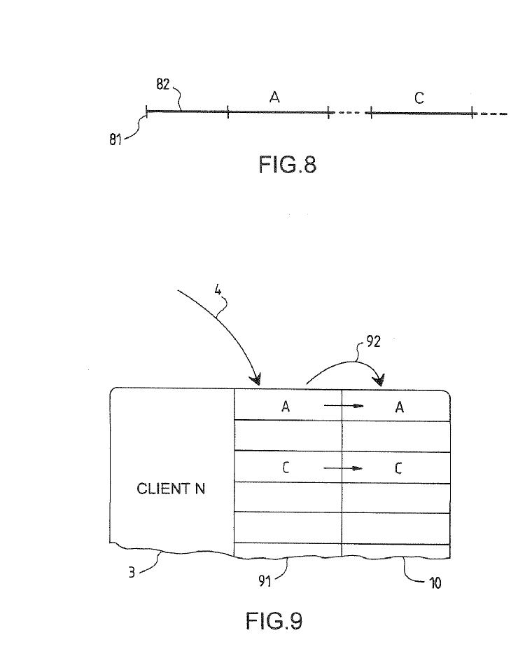

FIG. 8 shows an exemplary structure of a message 81 comprising the records sent by the server 1. This message structure makes it possible in particular to process the linked records. The message 81 has a serial data structure and comprises a header 82 followed by records. The header 82 indicates the number N of records contained in the message. The N records include the linked records A and C. A client must then place the records received in its database 10 only if it has received all the N records. A client knows that it has received a record from, in particular, the tests (1), (2) described previously. Each client therefore has an internal buffer, in which it stores the received records.

FIG. 9 illustrates in particular the operation of this buffer. A client 3 therefore comprises a buffer 91 in which it receives the linked records A, C and, more generally, all the other records, whether linked or independent. The buffer occupies a dedicated memory area in the client. In particular, to take account of the linked records, the client processes the buffer 91 as a record A, in the way described in light of FIG. 6 in particular. The method according to the invention applies to the buffer the protocol described above for a record A. Thus, the version of a buffer is considered correct when all the versions of its records A, C are correct. As long as the version of its buffer 91 is not correct, the client 3 asks the master 31 to continue resending the records A, C to it. When the version of the buffer is correct, the client swaps 92 the data from the buffer into its database 10.

It may be that a transmission fault affects the header 82, that is, that the content of the latter is not received by a client. The client then notices that it has not received the content of the header and initiates a request to the master for a retransmission of the complete message 81, including the header. The master, for example, retains in memory that the data items A, C are grouped and then retransmits the whole of the message 81 with the header 82.

The convergence time in the event of failures for an air traffic management application can, for example, be between 1 and 5 seconds. This convergence period corresponds to the MAC message sending interval, that is, an MAC message is then sent every Δt, Δt being, for example, between 1 and 5 seconds. The updated records A, C are sent via the multicast link 4 at any instant, in particular independently of the record convergence periods. In each convergence period, the master sends the MAC message then begins the convergence transactions between the master and the clients: tests on the versions of the records received, request for retransmission of the unreceived records, with or without iteration. At a given instant, all the databases 10 converge. They are identical, they have the same version. Advantageously, a method according to the invention does not manage record histories, it manages only the last version. In particular, whether there are 10, 100 or even 1000 machines in the network, even more, the performance levels are the same. The response times are not linked to the number of machines, in particular because the version tests (1), (2) are decentralized in each machine and the retransmissions after the retransmission requests made in parallel are conducted for each convergence period to all the machines in multicast mode.

In the exemplary application of FIGS. 3 and 6, a single server is shown. An application can, obviously, use several servers. Such is in particular the case for an air traffic management system where the system can have a server dedicated to flight plans, a server dedicated to meteorological data, a server dedicated to runway data, and so on. In this case, each of these servers writes the corresponding records into the database 10.

In the exemplary embodiment of FIGS. 3 and 6, the server 1 and the master 31 are two separate machines. However, it is possible to provide for applications where the master 31 also originates the updating of the data. In other words, one and the same machine can be both master and writer, a writer originating the writing or the modification of a data item or of a record.

The invention has been described for an air traffic management system, but it can nevertheless apply to numerous other systems comprising networked machines that use one and the same database.

1. A method of duplicating a database among the machines of a network, a machine of the network transmitting a data item updated in its database to the other machines comprising the steps of:
transmitting a message by the machine originating the data item transmitting, in the same message with this data item, its version number and an address of the machine;
the machine also transmitting the message to a master machine;
another machine publishing the data item in its database after a version number test;
the master machine periodically transmitting a central announcement message to the machines, this central announcement message comprising, for each data item in the database, its version number and the address of the machine originating its update.

2. The method as claimed in claim 1, wherein when a central announcement message is received, a machine compares the versions of the data items in its database with the versions of the central announcement message, the machine requesting the transmission of a data item to the master machine when the version number of the data item is less than the version number of the central announcement message.

3. The method as claimed in claim 1, wherein one machine originating the data item retransmits this data item to the other machines and the master machine when the version number of the data item that it has transmitted is greater than the version number of the central announcement message.

4. The method as claimed in claim 1, wherein when a one machine transmits two linked data items, on reception, the other machines store the received data items in a buffer area, the linked data items being published in the database of the machine when they have the version transmitted by the originating machine.

5. The method as claimed in claim 1, wherein the central announcement message is transmitted periodically, independently of the transmissions of data items by a machine.

6. The method as claimed in claim 1, wherein the data items are transmitted via a multicast link.

7. The method as claimed in claim 1, wherein the central announcement message is transmitted via multicast link.

8. The method as claimed in claim 1, wherein the network of machines is an air traffic management system.

9. A system of networked machines sharing one and the same database, the database being duplicated in the machines, an originating machine transmitting a data item updated in its database to the other machines, said system comprising:
a master machine which converges the databases:
the machine originating the data item including means for transmitting, in one and the same message with this data item, its version number and the address of the machine; and also transmitting the message to a master machine;
means for publishing the data item in a database of the machine publishing the data item after a version number test;
the master machine including means for transmitting a central announcement message to the machines, this central announcement message comprising, for each database, its version number and the address of the machine originating its update.

10. The system as claimed in claim 9, comprising:
a means for comparing on reception of a central announcement message, the versions of the data in its database with the versions of the central announcement message, and the means for requesting the transmission of a data item to the master machine when the version number of the data item is less than the version number of the central announcement message.

11. The system as claimed in claim 1, wherein the machine originating the data item retransmits this data item to the other machines and the master machine when the version number of the data item that it has transmitted is greater than the version number of the central announcement message.

12. The system as claimed in claim 1, wherein when a machine transmits two linked data items, on reception, the machines store the received data items in a buffer area, the linked data items being published in the database of the machine only when they have the version transmitted by the originating machine.

13. The system as claimed in claim 1, wherein the central announcement message is transmitted periodically, independently of the transmissions of data items by a machine.

14. The system as claimed in claim 1, wherein the data items are transmitted by multicast link.

15. The system as claimed in claim 1, wherein the central announcement message is transmitted via multicast link.

16. The system as claimed in claim 1, wherein it performs air traffic control management.
